(19) United States
(12) Patent Application Publication
(10) Pub. No.: US 2019/0236888 A1
(43) Pub. Date: Aug. 1, 2019

(54) Multi-chamber coin container

(71) Applicants: Craig Eric Klinger, Great Neck, NY (US); Jose Bernardo Toro Arbelaez, Remsenburg-Speonk, NY (US)

(72) Inventors: Craig Eric Klinger, Great Neck, NY (US); Jose Bernardo Toro Arbelaez, Remsenburg-Speonk, NY (US)

(21) Appl. No.: 15/884,307

(22) Filed: Jan. 30, 2018

(51) Int. Cl. G07D 9/00

(52) U.S. Cl. CPC G07D 9/002

(57) ABSTRACT

The presented invention is a reusable multi-chamber coin container with means for storage and transport of coin-based currency or coin-shaped objects and is comprised of two symmetrical interchangeable halves which, when assembled with two halves in an opposing orientation, contain a plurality of chambers to accommodate multiple stacks of coins or stacks of coin-shaped objects. When assembled, the multi-chamber coin container allows for ease of storage of coin-based currency or coin-shaped items and is reusable.

### CROSS-REFERENCE TO RELATED APPLICATIONS

This application claims the benefit of U.S. Provisional Application No. 62/454,137, filed on 2 Feb. 2017, the contents of which are all incorporated by reference.

### FIELD OF THE INVENTION

The present invention relates to a reusable multi-chamber container for storage and transport of coin-based currency or coin-shaped objects.

### BACKGROUND INFORMATION

The present invention relates specifically to a reusable multi-chamber container for bulk storage of coin-based currency or coin-shaped objects. The coin container according to an example embodiment of the present invention is comprised of two symmetrical interchangeable halves which, when assembled with two halves in an opposing orientation with their top surfaces mated together, contain a plurality of chambers to accommodate multiple stacks of coins. When assembled, the halves allow for ease of storage of coin-based currency or coin-shaped objects.

The use of symmetrical interchangeable halves provides numerous advantages over reusable coin containers of the prior art. One advantage in particular relates to ease of manufacture. As the two sides are symmetrical the manufacturing process is simplified eliminating need to manufacture both top and bottom halves with different molds and/or manufacturing techniques. For example, the coin container halve can be manufactured, through injection molding, and used in duplicate as the halves are symmetrical. This may thereby simplify manufacturing complexity and thereby reduce tooling costs. Additionally, the multi-chamber coin container may offer improved ease of assembly and use. For example, if the user has numerous multi-chamber coin containers to assemble for coin storage, the selection of top and bottom halves is not necessary as the halves are interchangeable and symmetrical with respect to top and bottom constituent parts. This simplification thereby may save the user time.

Furthermore, the multi-chamber coin container allows for ease of coin collection, using the container, as the length of each chamber corresponds to a set number of arranged coins in multiple stacks. Therefore, coin counting is unnecessary as the multi-chamber coin container is successively filled by the user until each chamber is filled and allows for bulk storage. This may save the user time as compared to counting of individual coins and assembly of a coin stack into a paper-based coin roll, commonly used for banking deposits. This ease of use may thereby simplify the deposit process for coins as coins do not need to be counted for deposits saving time for the bank customer, as compared to use of paper-based coin rolls. The multi-chamber coin container may then be transported by the user to a banking institution for easier bulk coin deposit. It may also be used to store and transport casino tokens or other coin-shaped objects.

Another possible advantage of the multi-chamber coin container is reusability. The multi-chamber coin container assembly/ies can be used to transport arranged coins for deposit to a banking institution. They may then be processed and weighed by the bank representative and returned to the customer at the time of the deposit transaction. This process may either be performed simultaneous to the deposit procedure whereby the customer receives the multi-chamber coin container halves used for their coin deposit or they may receive empty multi-chamber coin container halves processed prior to their own deposit transaction, or an unused multi-chamber coin container assembly. This process is in contrast to that often employed with paper-based coin rolls commonly used for deposits of coin-based currency. Following deposit of paper-based coin rolls, the coin rolls are typically weighed and then opened by bank and not reused prior to material recycling. Thus, the paper-based coin rolls are commonly designed for single-use purposes unlike the multi-chamber coin container of the present disclosure which are designed to be reusable. Paper-based coin rolls are often single use in design requiring end-folding for sealing purposes, which negatively affects the coin roll strength and durability, thereby limiting their life cycle to single-use purposes. Furthermore, the paper-based coin rolls may be marked by the user with identification markings including their bank account number in order for the bank to associate each deposited coin roll to a customer. An additional advantage with the multi-chamber coin container is the ability to use a separate paper identification tag for denoting bank account identification information without writing directly onto the coin container itself, further allowing for repeat use by multiple bank customers, as desired.

Additionally, each multi-chamber coin container assemblies may be easily opened by the banking representative at time of deposit, if desired, for inspection and verification purposes and easily reassembled. This process is facilitated as the top halve of the multi-chamber coin container may be removed to confirm each chamber is properly filled with the correct coins. Thus, accurate visual assessment may easily be achieved with the multi-chamber coin container assemblies. Such visual confirmation is difficult to achieve at time of deposit of paper-based coin rolls as visual assessment would require removal of the coins from each coin roll, and once opened, they are difficult to refill using the same coin roll. Thus, with use of paper-based coin rolls, weighing is often employed as visual assessment is difficult. With the multi-chamber coin container, however, visual inspection at time of deposit is easily accomplished while secondary confirmation by weight is still achievable. Thus, two means of verification are possible at time of deposit with the multi-chamber coin container assembly, which is an advantage over paper-based coin rolls. Furthermore, the multi-chamber coin container may be manufactured with a transparent form of polycarbonate allowing for visual inspection of container contents without requiring opening of the container or coin removal. This provides a further advantage over paper-based coin rolls which would require emptying of the coin roll to allow visual inspection of its contents.

### SUMMARY

The assembled multi-chamber coin container according to an example embodiment of the present invention includes a plurality of chambers for stacks of coins using interchangeable, symmetrical top and bottom halves which can be reused following coin transport for banking deposit transactions. Coin deposits often rely on the use of paper-based coin rolls which are typically single use in design as they require end-folding for sealing purposes which thus negatively affects the coin roll strength and durability. As the multi-chamber coin contain is reusable numerous deposit transactions can be completed during its life-cycle providing benefits afforded through reusable packaging. The multi-chamber coin container allows for ease of coin collection as the length of each chamber corresponds to a set number of coins allowing for rapid coin assembly within the container without need for individual coin counting which is an advantage over the commonly used, paper-based coin rolls. With the multi-chamber coin container, visual assessment at time of deposit is easily accomplished while secondary confirmation by weight is also achievable. This is an additional benefit over existing coin rolls which are not easily refilled once opened at time of deposit. The multi-chamber coin container affords the ability to use a separate paper tag for denoting bank account identification.

### BRIEF DESCRIPTION OF THE DRAWINGS

FIG. 1A is a front view of a five-chamber coin container halve.

FIG. 1B is a back view of the five-chamber coin container halve.

FIG. 1C is a left view of a of the five-chamber coin container halve.

FIG. 1D is a right view of the five-chamber coin container halve.

FIG. 1E is a top view of view of the five-chamber coin container halve.

FIG. 1F is a bottom view of the five-chamber coin container halve.

FIG. 1G is a left perspective view further illustrating the five-chamber coin container halve.

FIG. 1H is a right perspective view further illustrating the five-chamber coin container halve.

FIG. 1I is a front view of a five-chamber coin container assembly comprised of two five-chamber coin container halves.

FIG. 1J is a left perspective view of a five-chamber coin container assembly comprised of two five-chamber coin container halves.

FIG. 1K is a left exploded perspective view of a five-chamber coin container assembly and one paper tag, and five coin stacks.

FIG. 1L is a top view of a five-chamber coin container assembly and one paper tag, five coin stacks, and two rubber bands securing the two five-chamber coin container halves.

FIG. 1M is a left perspective view of the five-chamber coin container assembly with one paper tag, five coin stacks, and two rubber bands securing the two five-chamber coin container halves.

FIG. 2A is a front view of a four-chamber coin container halve.

FIG. 2B is a left view of the four-chamber coin container halve.

FIG. 2C is a top view of the four-chamber coin container halve.

FIG. 2D is a left perspective view of the four-chamber coin container halve.

FIG. 2E is a front view of a four-chamber coin container assembly comprised of two four-chamber coin container halves.

FIG. 2F is a left perspective view of the four-chamber coin container assembly with four coin stacks, and two rubber bands securing the two four-chamber coin container halves.

FIG. 3A is a front view of a three-chamber coin container halve.

FIG. 3B is a left view of the three-chamber coin container halve.

FIG. 3C is a top view of the three-chamber coin container halve.

FIG. 3D is a left perspective view of the three-chamber coin container halve.

FIG. 3E is a front view of a three-chamber coin container assembly comprised of two three-chamber coin container halves.

FIG. 3F is a left perspective view of the three-chamber coin container assembly with three coin stacks, and two rubber bands securing the two three-chamber coin container halves.

FIG. 4A is a front view of a two-chamber coin container halve.

FIG. 4B is a left view of the two-chamber coin container halve.

FIG. 4C is a top view of the two-chamber coin container halve.

FIG. 4D is a left perspective view of the two-chamber coin container halve.

FIG. 4E is a front view of a two-chamber coin container assembly comprised of two two-chamber coin container halves.

FIG. 4F is a left perspective view of the two-chamber coin container assembly with two coin stacks, and one rubber band securing the two two-chamber coin container halves.

FIG. 5A is a front view of a four-chamber coin container halve with central lip extension.

FIG. 5B is a left view of the four-chamber coin container halve with central lip extension.

FIG. 5C is a top view of the four-chamber coin container halve with central lip extension.

FIG. 5D is a left perspective view of the four-chamber coin container halve with central lip extension.

FIG. 5E is a front view of a two-chamber coin container assembly comprised of two four-chamber coin container halves.

FIG. 5F is a left perspective view of the four-chamber coin container with central lip extension assembly with four coin stacks, and two rubber bands securing the two four-chamber coin container halves.

FIG. 6A is a front view of a five-chamber coin container halve without a lip extension.

FIG. 6B is a left view of the five-chamber coin container halve without a lip extension.

FIG. 6C is a top view of the five-chamber coin container halve without a lip extension.

FIG. 6D is a left perspective view of the five-chamber coin container halve without lip extension.

FIG. 6E is a front view of a five-chamber coin container without lip extension assembly comprised of two five-chamber coin container halves without lip extensions.

FIG. 6F is a left perspective view of the five-chamber coin container without a lip extension assembly with five coin stacks, and two rubber bands securing the two five-chamber coin container halves without lip extensions.

FIG. 7A is a front view of a three-chamber coin container halve with a tall spine.

FIG. 7B is a left view of the three-chamber coin container halve with a tall spine.

FIG. 7C is a top view of the three-chamber coin container halve with a tall spine.

FIG. 7D is a left perspective view of the three-chamber coin container halve with a tall spine.

FIG. 7E is a front view of a three-chamber coin container with a tall spine assembly comprised of two three-chamber coin container halves with tall spines.

FIG. 7F is a left perspective view of the three-chamber coin container with a tall spine assembly with three coin stacks, and two rubber bands securing the two three-chamber coin container halves with tall spines.

FIG. 8A is a front view of a three-chamber coin container halve with a full spine.

FIG. 8B is a left view of the three-chamber coin container halve with a full spine.

FIG. 8C is a top view of the three-chamber coin container halve with a full spine.

FIG. 8D is a left perspective view of the three-chamber coin container halve with a full spine.

FIG. 8E is a front view of a three-chamber coin container with a full spine assembly comprised of two three-chamber coin container halves with full spines

FIG. 8F is a left perspective view of the three-chamber coin container with a tall spine assembly with three coin stacks, and two rubber bands securing the two three-chamber coin container halves with tall spines.

FIG. 9A is a front view of a coin tray for storage and transportation of multi-chamber coin containers.

FIG. 9B is a left view of the coin tray.

FIG. 9C is a top view of the coin tray.

FIG. 9D is an exploded left perspective view of four of four-chamber coin container with central lip extension assembly, each including four coin stacks and one paper tag and secured with two rubber bands each, into one coin tray.

FIG. 9E is a left perspective view further illustrating four of four-chamber coin container with central lip extension assembly, each including four coin stacks and secured with two rubber bands each, into one coin tray.

FIG. 9F is a front view illustrating the fit of the four stacked four-chamber coin container with central lip extension assembly within the coin tray.

### DETAILED DESCRIPTION

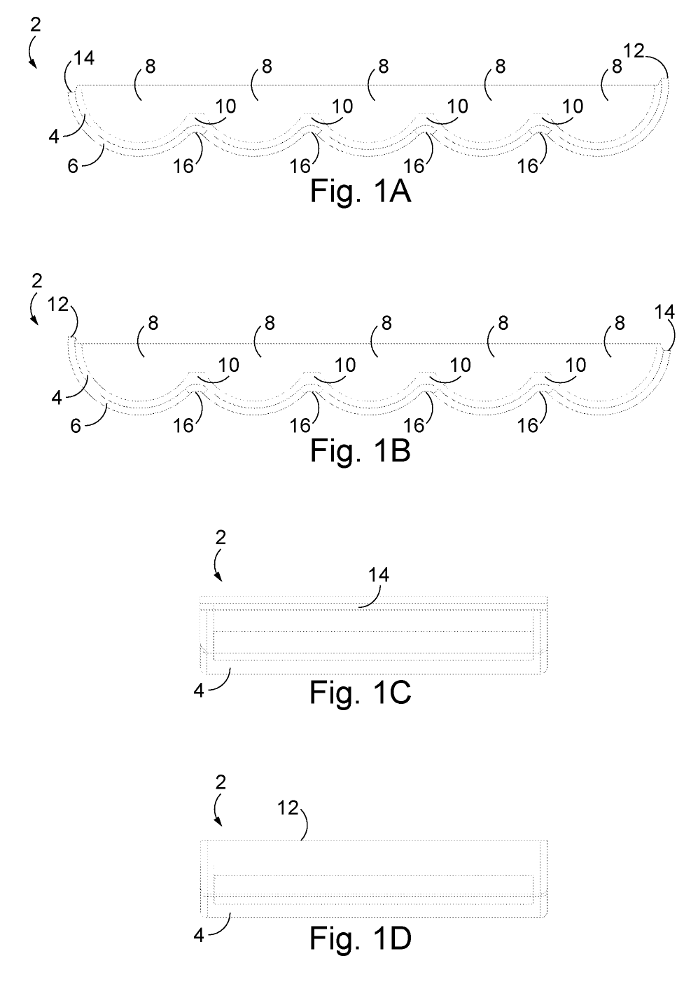

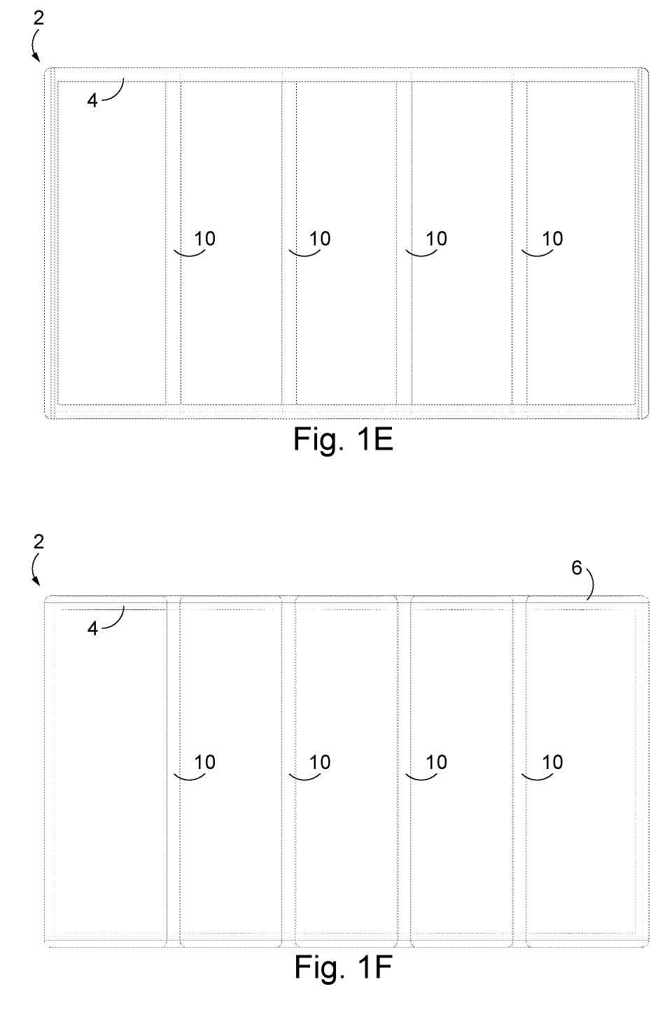

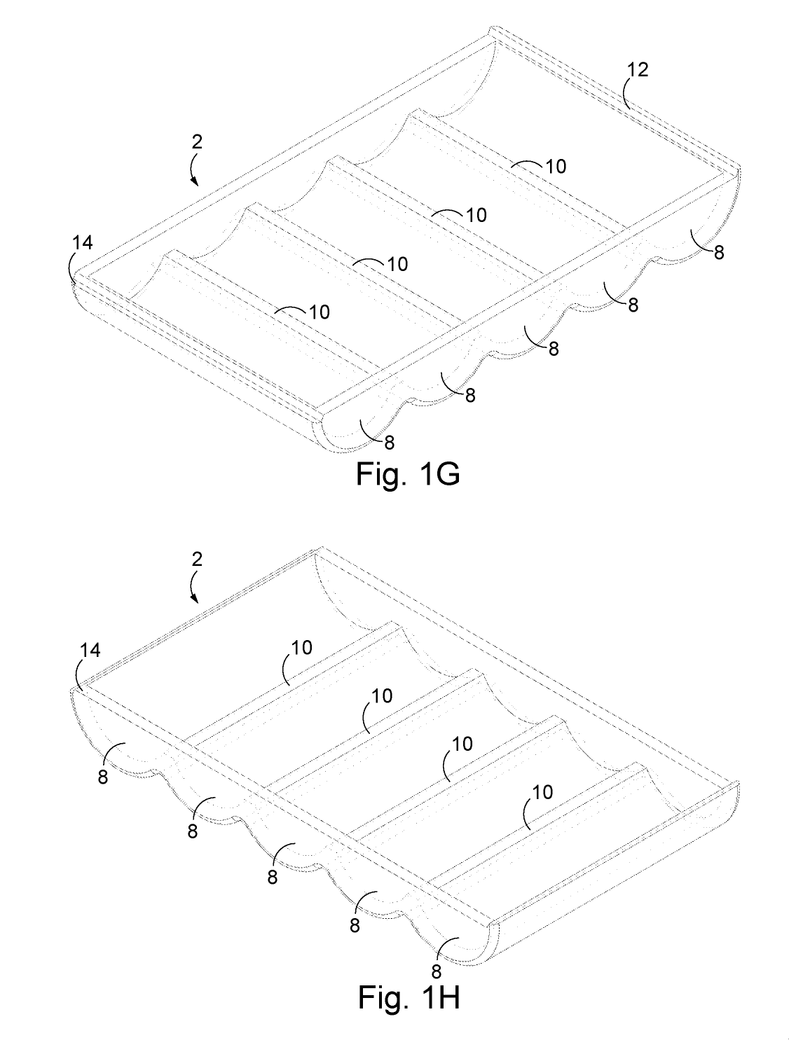

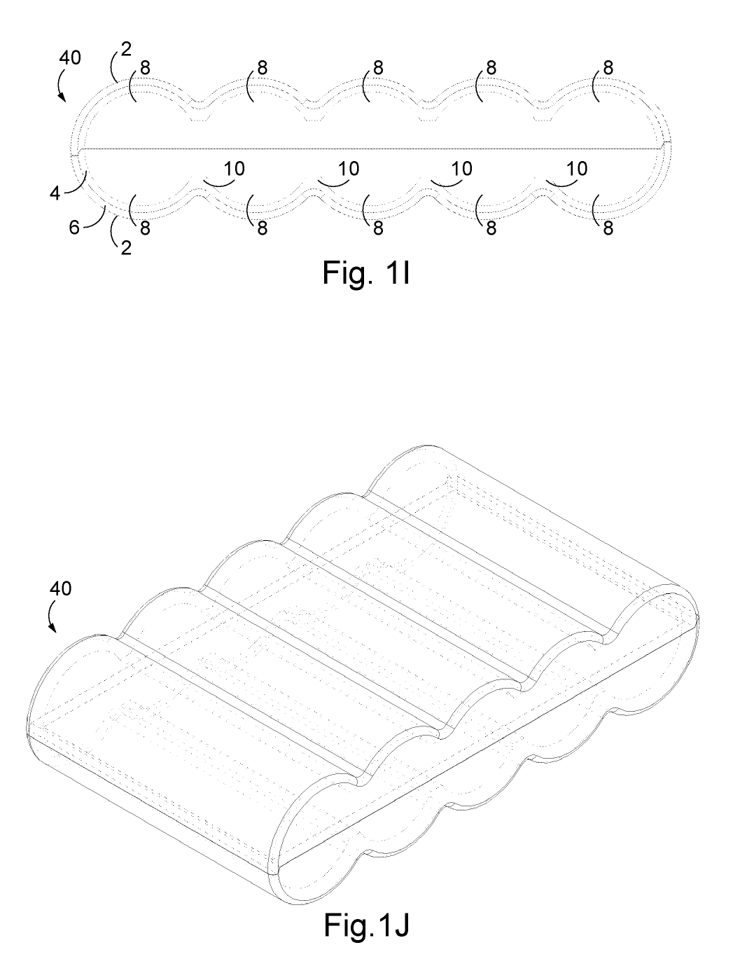

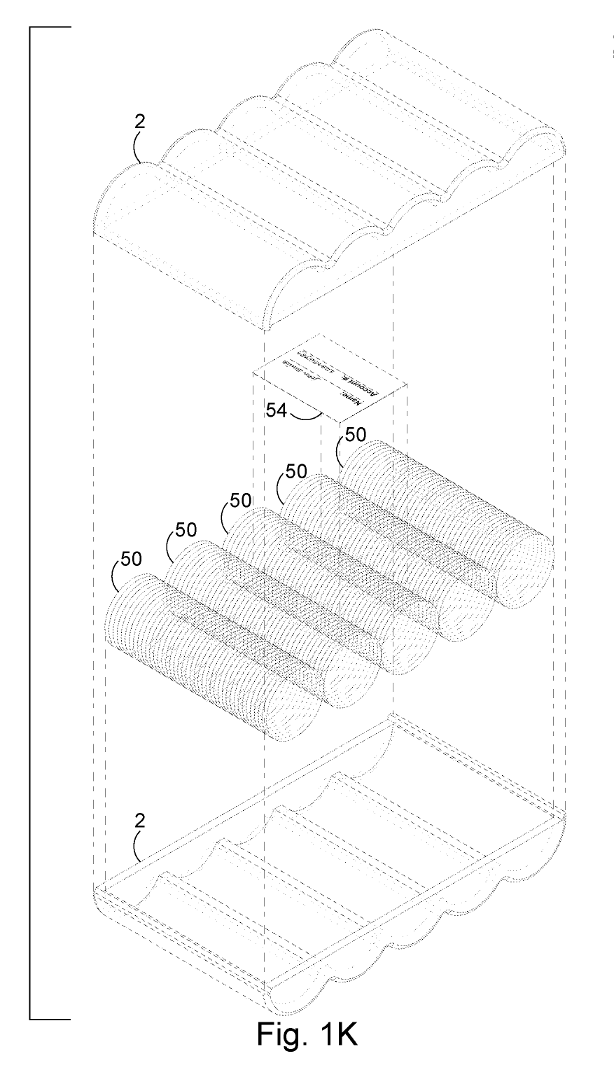

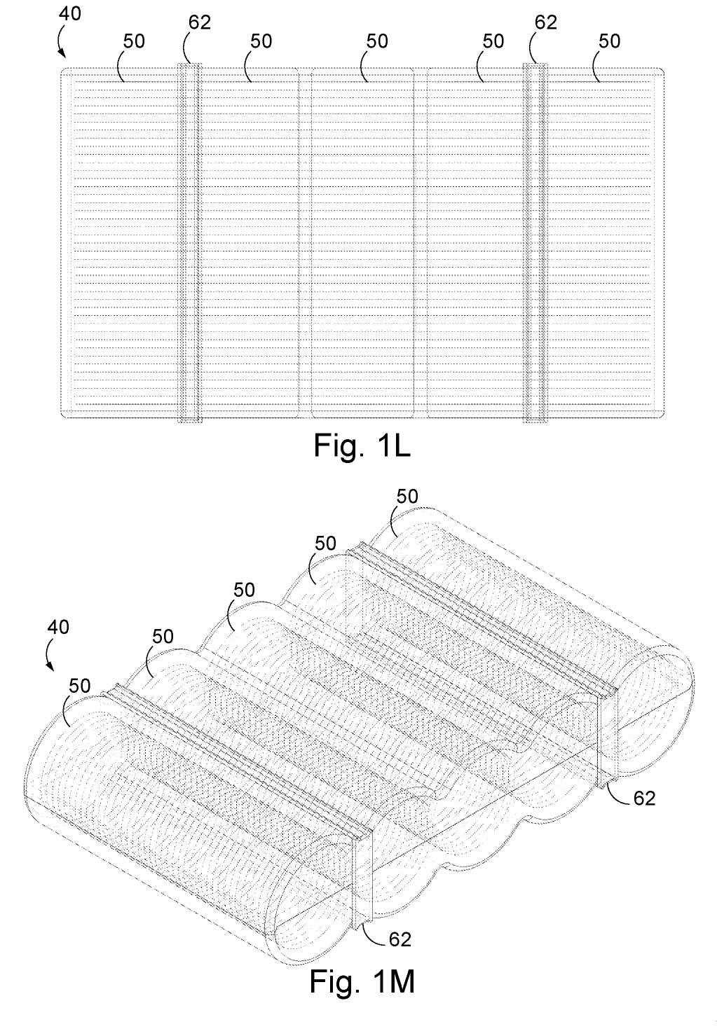

FIGS. 1A and 1B are front and back views, respectively, of a five-chamber coin container halve 2, used in duplicate, in accordance with one exemplary embodiment of the multi-chamber coin container of the present invention. The five-chamber coin container halve includes container wall 4 and filleted edge 6. Also present are five of semi-cylindrical, coin chamber 8 for accommodation of five stacks of coin currency and four of spine 10, located between each of the coin chambers. Along the top-right surface is outer lip extension 12 and along the top-left surface is outer lip recess 14. The outer lip extension fits into the outer lip recess when two symmetrical five-chamber coin containers are placed in an opposing orientation, with their top surfaces mated together, achieving a shape-fit. Along the undersurface of the five-chamber coin container halve are four of spine recess 16. The spine recesses allow for ease of stacking and a space-saving fit, when fully assembled with two halves in an opposing orientation, and then stacked vertically. FIGS. 1C and 1D are left and right views, respectively, of the five-chamber coin container further demonstrating the container wall 4, outer lip recess 14, and outer lip extension 12. FIGS. 1E and 1F are top and bottom views, respectively, of the five-chamber coin container halve 2 further illustrating the spines between chambers.

FIGS. 1G and 1H are left perspective and right perspective views further illustrating coin chamber 8, included in a plurality of five. FIGS. 1I and 1J are front and left perspective views, respectively, of a five-chamber coin container assembly 40 comprised of two five-chamber coin container halves 2 illustrating the shape-fit achieved once assembled as two halves with two halves in an opposing orientation with their top surfaces mated together. The use of symmetrical interchangeable halves provides numerous advantages. One advantage relates to ease of manufacture. As the two sides are symmetrical the manufacturing process is simplified eliminating need for manufacture of both top and bottom halves in separate tooling and manufacture processes. This simplifies manufacturing complexity and cost of producing separate molds, injection or otherwise, if manufactured using a molding technique. Additionally, the symmetrical multi-chamber coin container halves provide for simple use, as compared to use of an asymmetrical top and bottom halve. For example, if the user has numerous multi-chamber coin containers to assemble for coin storage, the selection of top and bottom halves is unnecessary as halves are interchangeable and symmetrical with respect to top and bottom constituent parts. This simplification saves the user time while reducing complexity of manufacturing.

FIG. 1K is a left exploded perspective view of a five-chamber coin container assembly with one paper tag 54, and five of coin stack 50. Inclusion of a plurality of coin chambers accommodates multiple coin stacks for bulk coin deposits. The paper tag is sized to fit into the multi-chamber coin container and can include an area for the user to denote information along its surface using a pen or other writing instrument. Information which can be recorded may include banking customer name, bank account number or other information. For example, the user may write their name and bank account number in a designated region of the paper tag in order to comply with individual banking procedures, and can be altered to comply with individual banking institution policies. The paper tag is placed into the full five-chamber coin container halve 2, and above the coin stack, the second the five-chamber coin container halve is placed in an opposing orientation as illustrated and the paper tag bends along the contour of the coin stack, as the container is assembled into its shape fit. FIGS. 1L and 1M are top and left perspective views of a five-chamber coin container assembly 40 and one paper tag, five coin stacks, with two of rubber band 62 securing the two five-chamber coin container halves. Each rubber band can be placed along the narrow portion of the three-chamber coin container assembly 40 as illustrated, along the spine recess area of each respective halve.

The multi-chamber coin container halves may be produced for coins or coin shaped-objects of varying sizes. This is achieved by changing the diameter of the coin chambers in order to accommodate smaller or larger diameter coins or coin-shaped objects including casino tokens. For example, if the multi-chamber coin container needs to store coins of a smaller coin diameter the coin chamber in the multi-chamber coin container halve may be produced with smaller diameter coin chambers and the container wall may also be scaled in dimension accordingly. The alternate is also true whereby the coin chamber may be enlarged in diameter if a larger coin diameter is to be stored with corresponding modifications made to the container wall to accommodate the enlarged coin chambers. Additionally, the coin chamber length may also be enlarged or reduced in size to accommodate coins of varying thickness.

The five-chamber coin container halve in this embodiment may be manufactured using a polymer such as polycarbonate material. Additionally, it may be manufactured using an alternate polymer including polyethylene, polypropylene, polyvinyl chloride. Alternate materials can also be used to manufacture the five-chamber coin container including silicone, metal including aluminum, metal alloy, or other suitable material including carbon fiber. If the container is produced with polycarbonate it may be manufactured through injection molding or other molding technique or thermoformed as known in the art and further contoured as desired. If polycarbonate is used in the manufacture, it may also be transparent polycarbonate as known in the art. If metal is used in the manufacture, it can be formed as cast, forged, and further machined or alternate process as known in the art. The surface can be further polished, painted, stained or anodized if aluminum is utilized, as known in the art. The five-chamber coin container assembly may be filled with an appropriate coin denomination and used for storage and transport of coin-based currency to an accommodating banking institution for deposit. In addition to the user the banking institution may also benefit from use of the multi-chamber coin container. The coin stacks may be easily visually inspected by the banking representative at time of deposit as the multi-chamber coin container allows for easy of assembly and reassembly by simply removing the rubber bands and top halve. If transparent polycarbonate is used in the manufacture of the multi-chamber coin container visual inspection can also be further simplified at time of deposit as the coin stacks may be viewed through the coin container itself.

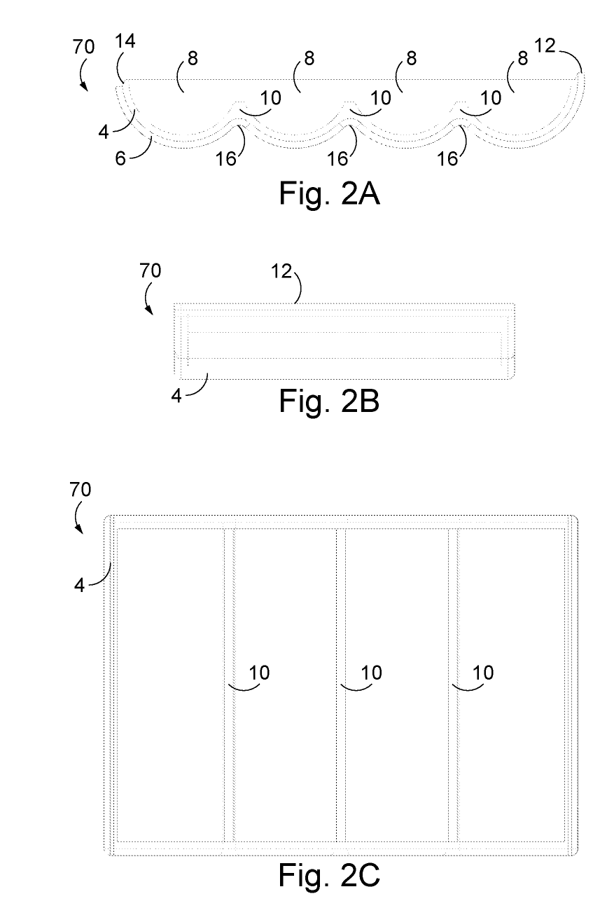

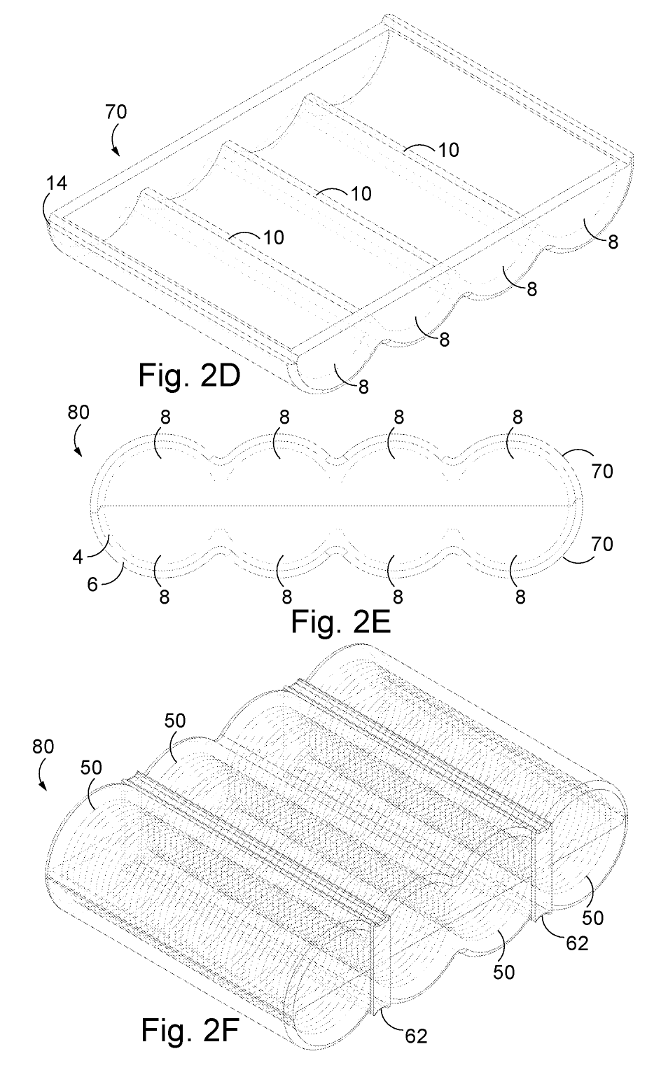

FIGS. 2A, 2B and 2C are front, left and top views, respectively, of a four-chamber coin container halve 70, used in duplicate, in accordance with one exemplary embodiment of the multi-chamber coin container of the present invention. The four-chamber coin container halve, material and steps for manufacture are the same as that illustrated and described in FIGS. 1A to 1M with a few differences, which are described below. The four-chamber coin container halve also includes container wall 4 and filleted edge 6. Four of coin chamber 8 are included for accommodation of four stacks of coin currency and three of spine 10 are located between individual coin chambers. Along the top-right surface is outer lip extension 12 and along the top-left surface is outer lip recess 14. The outer lip extension fits into the outer lip recess when two symmetrical five-chamber coin containers are placed in an opposing orientation achieving a shape-fit. Along the undersurface of the four-chamber coin container halve are three of spine recess 16 allowing for ease of stacking with a shape-fit, when fully assembled with two halves in an opposing orientation with their top surfaces mated together, and then stacked vertically. FIG. 2D is a left perspective view further illustrating the location of each coin chamber 8. FIG. 2E is a front view of a four-chamber coin container assembly 80 comprised of two four-chamber coin container halves 70 illustrating the shape-fit achieved once assembled with two halves in an opposing orientation with their top surfaces mated together. FIG. 2F is a left perspective view of the four-chamber coin container assembly with four coin stacks, and two rubber bands securing the two four-chamber coin container halves. Each rubber band can be placed along the narrow portion of the four-chamber coin container assembly 80 as illustrated, along the spine recess area of each respective halve. The multi-chamber coin container of the present embodiment accommodates a smaller number of coin stacks and is thereby smaller in the width dimension. Accordingly, less material is therefore needed to manufacture the four-chamber coin container.

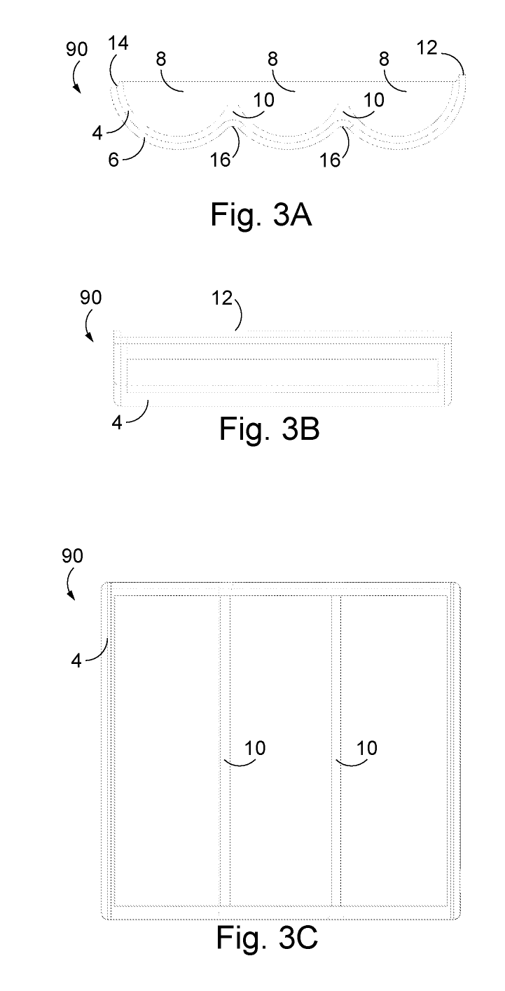

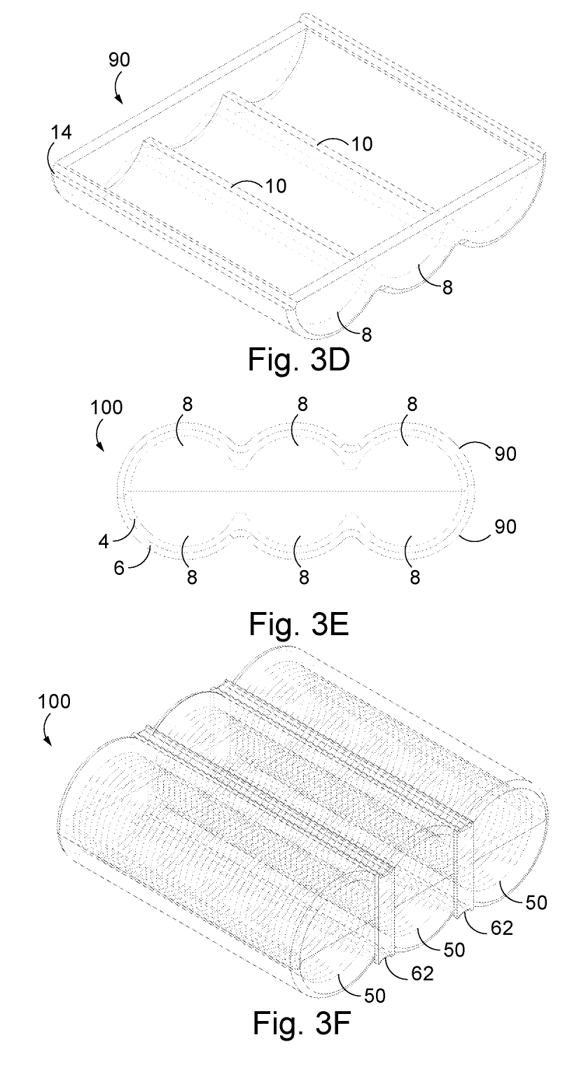

FIGS. 3A, 3B and 3C are front, left and top views, respectively, of a three-chamber coin container halve 90, used in duplicate, in accordance with one exemplary embodiment of the multi-chamber coin container of the present invention. The three-chamber coin container halve, material and steps for manufacture are the same as that illustrated and described in FIGS. 2A to 2F with a few differences, which are described below. The three-chamber coin container halve also includes container wall 4 and filleted edge 6. Three of coin chamber 8 are included for accommodation of three stacks of coin currency and two of spine 10 are located between individual coin chambers. Along the top-right surface is outer lip extension 12 and along the top-left surface is outer lip recess 14. The outer lip extension fits into the outer lip recess when two symmetrical three-chamber coin containers are placed in an opposing orientation with their top surfaces mated together achieving a shape-fit. Along the undersurface of the three-chamber coin container halve are two of spine recess 16 allowing for ease of stacking with a space-saving fit, when fully assembled as two halves, and then stacked vertically. FIG. 3D is a left perspective view further illustrating the location of each coin chamber 8. FIG. 3E is a front view of a three-chamber coin container assembly 100 comprised of two three-chamber coin container halves 90 illustrating the shape-fit achieved once assembled with two halves in an opposing orientation with their top surfaces mated together. FIG. 3F is a left perspective view of the three-chamber coin container assembly with three coin stacks, and two rubber bands securing the two three-chamber coin container halves. Each rubber band can be placed along the narrow portion of the three-chamber coin container assembly 100 as illustrated, along the spine recess area of each respective halve. The multi-chamber coin container of the present embodiment accommodates a smaller number of coin stacks and is thereby smaller in the width dimension. Accordingly, less material is therefore needed to manufacture the three-chamber coin container.

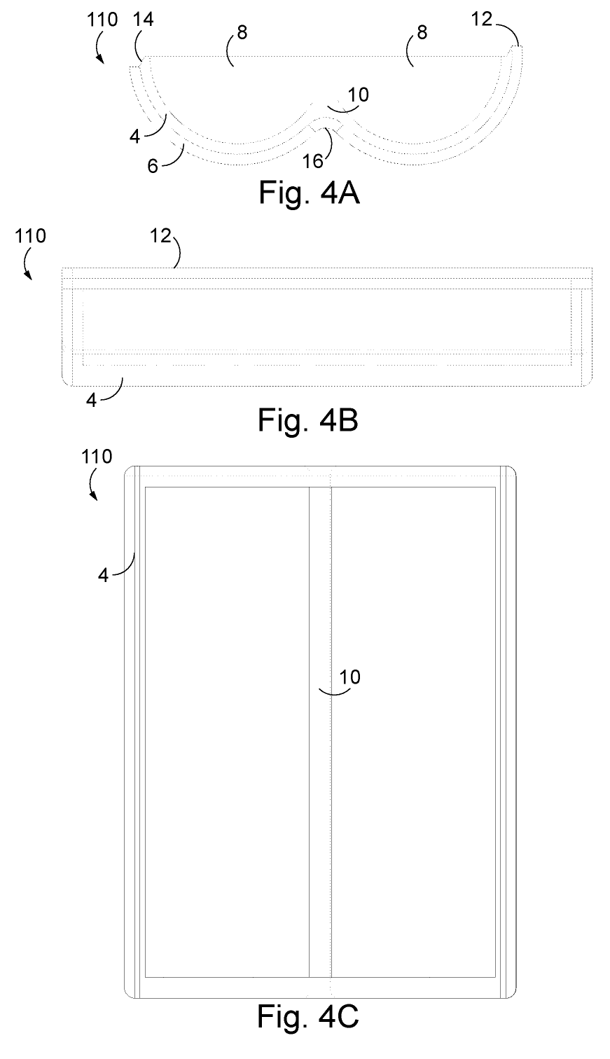

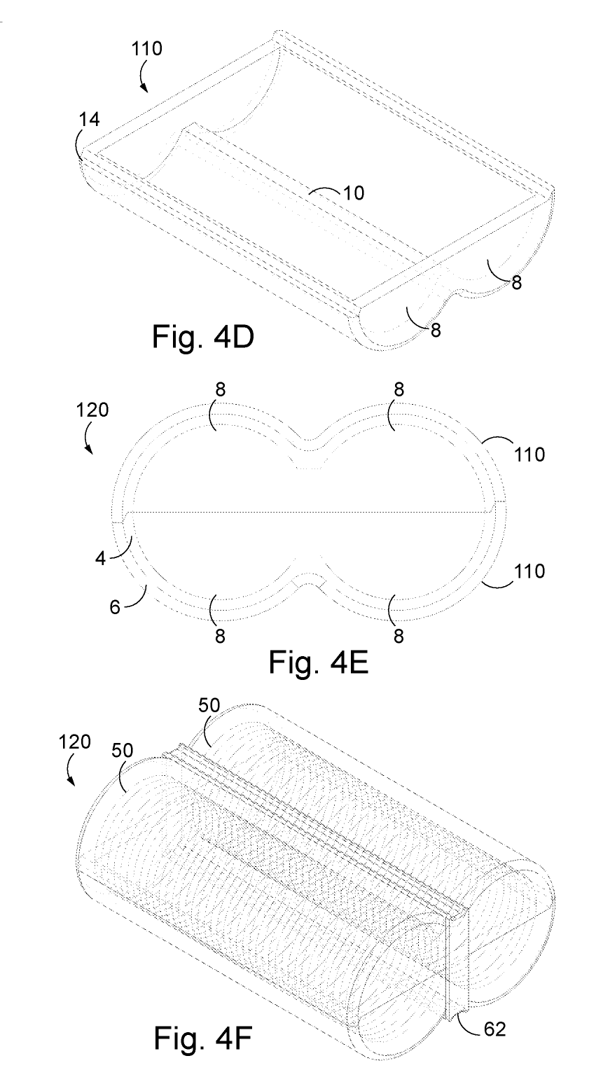

FIGS. 4A, 4B and 4C are front, left and top views, respectively, of a two-chamber coin container halve 110, used in duplicate, in accordance with one exemplary embodiment of the multi-chamber coin container of the present invention. The two-chamber coin container halve, material and steps for manufacture are the same as that illustrated and described in FIGS. 2A to 2F with a few differences, which are described below. The two-chamber coin container halve also includes container wall 4 and filleted edge 6. Two of coin chamber 8 are included for accommodation of two stacks of coin currency and one of spine 10 are located between individual coin chambers. Along the top-right surface is outer lip extension 12 and along the top-left surface is outer lip recess 14. The outer lip extension fits into the outer lip recess when two symmetrical two-chamber coin containers are placed in an opposing orientation with their top surfaces mated together achieving a shape-fit. Along the undersurface of the two-chamber coin container halve are two of spine recess 16 allowing for ease of stacking with a space-saving fit, when fully assembled as two halves, and then stacked vertically. FIG. 4D is a left perspective view further illustrating the location of each coin chamber 8. FIG. 4E is a front view of a two-chamber coin container assembly 120 comprised of two two-chamber coin container halves 110 illustrating the shape-fit achieved once assembled with two halves in an opposing orientation with their top surfaces mated together. FIG. 4F is a left perspective view of the two-chamber coin container assembly with two coin stacks, and one rubber band securing the two two-chamber coin container halves. The rubber band can be placed along the narrow portion of the two-chamber coin container assembly 120 as illustrated, along the spine recess area of each respective halve. The multi-chamber coin container of the present embodiment accommodates a smaller number of coin stacks and is thereby smaller in the width dimension. Accordingly, less material is therefore needed to manufacture the three-chamber coin container.

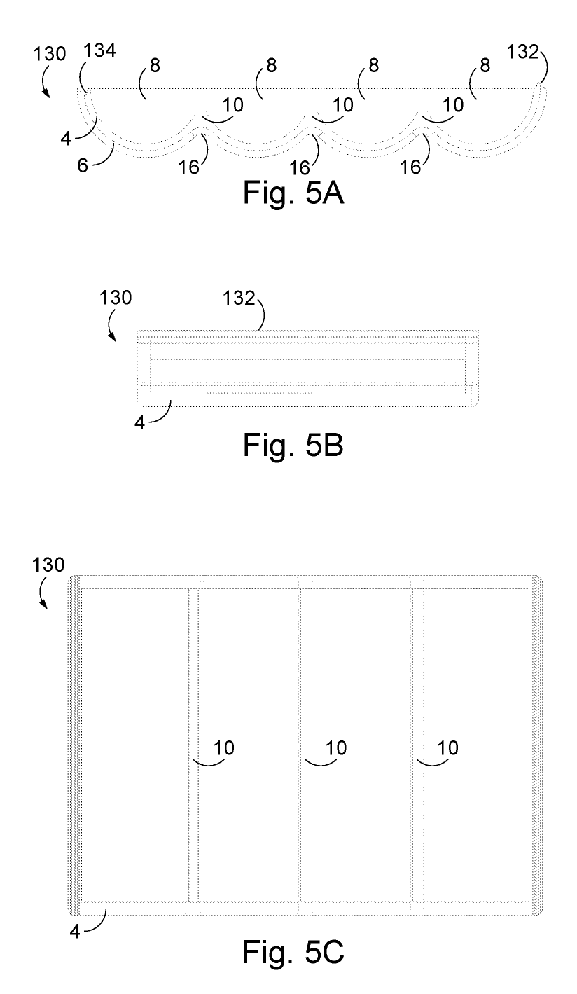

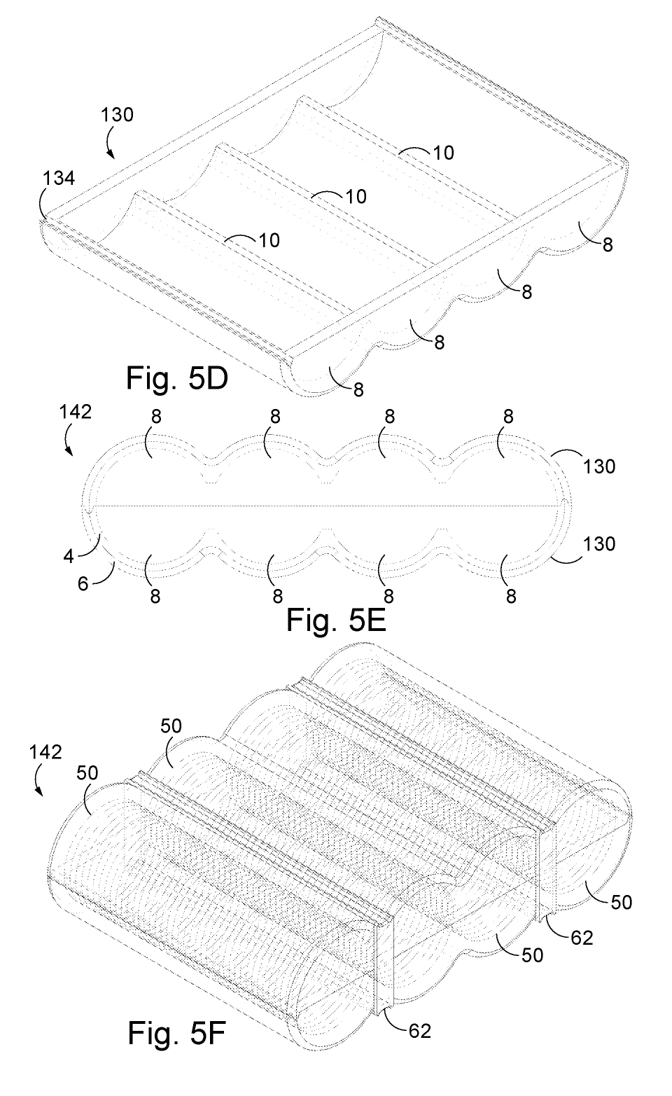

FIGS. 5A, 5B and 5C are front, left and top views, respectively, of a four-chamber coin container halve with central lip 130, used in duplicate, in accordance with one exemplary embodiment of the multi-chamber coin container of the present invention. The four-chamber coin container halve with central lip, material and steps for manufacture are the same as that illustrated and described in FIGS. 2A to 2F with a few differences, which are described below. The four-chamber coin container halve with central lip also includes container wall 4 and filleted edge 6. Four of coin chamber 8 are included for accommodation of four stacks of coin currency and three of spine 10 are located between individual coin chambers. Along the top-right surface is central lip extension 132 and along the top-left surface is central lip recess 134. The outer lip extension fits into the outer lip recess when two symmetrical two-chamber coin containers are placed in an opposing orientation with their top surfaces mated together achieving a shape-fit. The central location of both the central lip extension along the top surface of the right container wall and central lip recess along the top surface of the left container wall also help in ensuring the halves stay aligned when in use with rubber bands securing the two halves. Along the undersurface of the four-chamber coin container halve with central lip 130 are three of spine recess 16 allowing for ease of stacking with a space-saving fit, when fully assembled as two halves, and then stacked vertically. FIG. 5D is a left perspective view further illustrating the location of each coin chamber 8. FIG. 5E is a front view of a four-chamber coin container with central lip extension assembly 142 comprised of two two-chamber coin container halves with central lip 130 illustrating the shape-fit achieved once assembled with two halves in an opposing orientation with their top surfaces mated together. FIG. 5F is a left perspective view of the four-chamber coin container with central lip extension assembly with four coin stacks, and two rubber bands securing the two four-chamber coin container halves. The rubber bands can be placed along the narrow portion of the four-chamber coin container with central lip extension assembly 142 as illustrated, along the spine recess area of each respective halve. The multi-chamber coin container of the present embodiment offers the further benefit further aiding alignment of the assembled container halves during storage and transport. This is achieved by the central location of both the central lip extension along the top surface of the right container wall and central lip recess along the top surface of the left container wall which can help ensure the halves stay better aligned through a shape fit with left-right lateral translation between the two halves less likely.

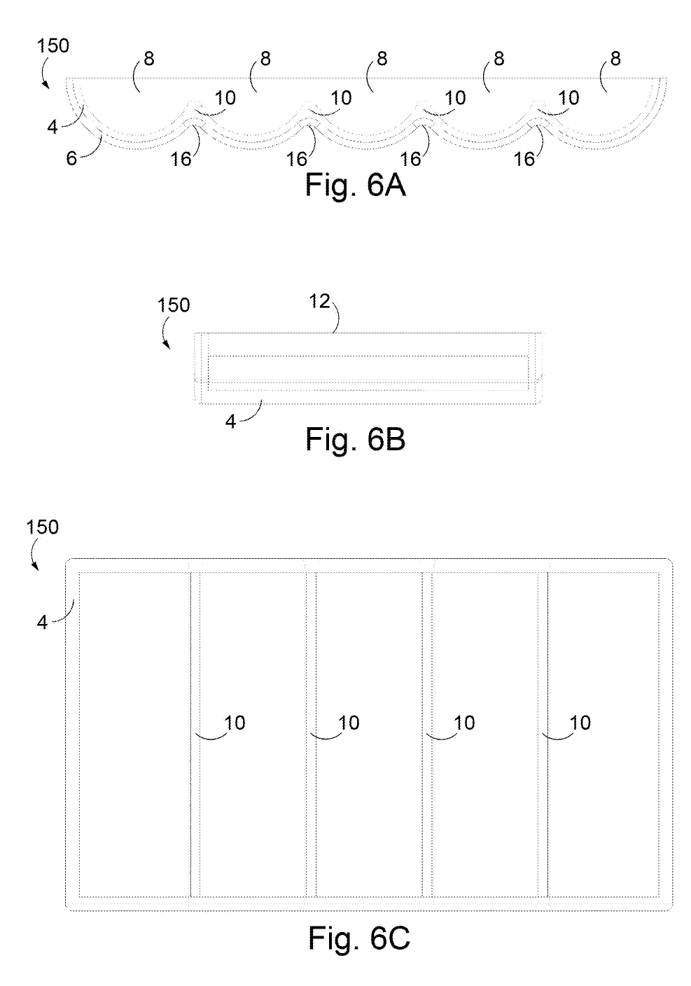

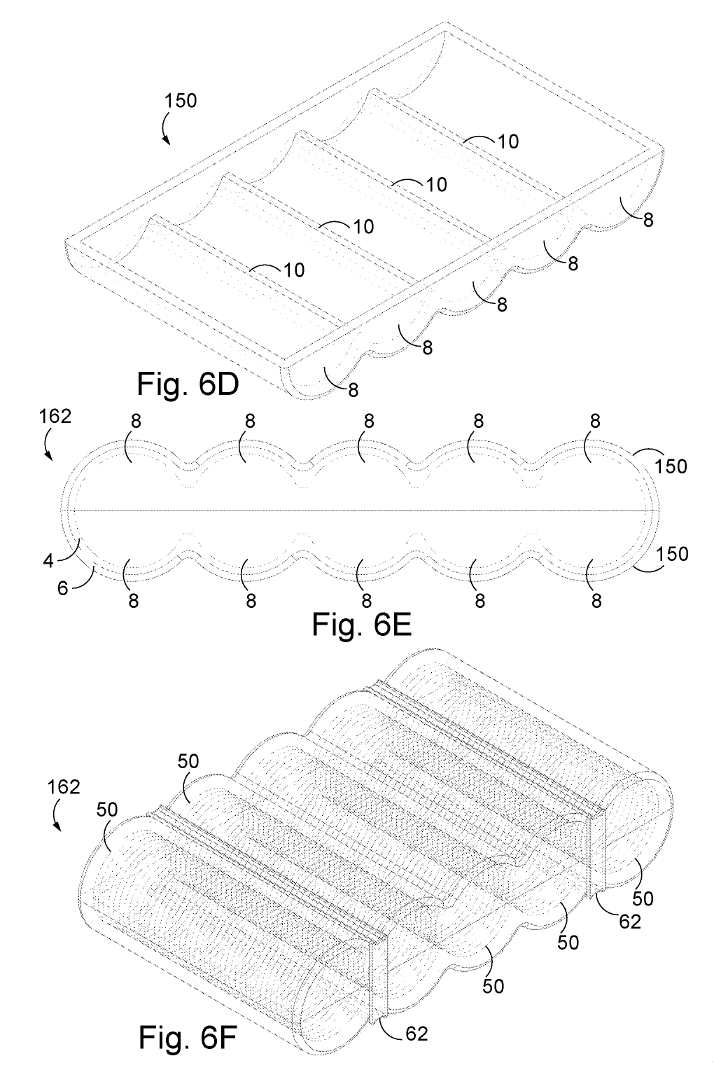

FIGS. 6A, 6B and 6C are front, left and top views, respectively, of a five-chamber coin container halve without a lip 150, used in duplicate, in accordance with one exemplary embodiment of the multi-chamber coin container of the present invention. The Five-chamber coin container halve without a lip, material and steps for manufacture are the same as that illustrated and described in FIGS. 5A to 5F with a few differences, which are described below. The five-chamber coin container halve without a lip also includes container wall 4 and filleted edge 6. Five of coin chamber 8 are included for accommodation of five stacks of coin currency and four of spine 10 are located between individual coin chambers. Neither a lip extension nor lip recess are included in this embodiment. Omission of these features in this version further simplifies the manufacture and mold, when utilized and used for production, as compared to those versions which include the lip extension and lip recess. It may also provide for improved durability as inclusion of the lip recess also removes material from the container wall and this area may thereby be weakened as compared to an area with a full thickness container wall. Along the undersurface of the five-chamber coin container halve without a lip 150 are four of spine recess 16 allowing for ease of stacking with a space-saving fit, when fully assembled as two halves, and then stacked vertically. FIG. 6D is a left perspective view further illustrating the location of each coin chamber 8. FIG. 6E is a front view of a five-chamber coin container without a lip extension assembly 162 comprised of two five-chamber coin container halves without a lip 150 illustrating the fit achieved once assembled with two halves in an opposing orientation with their top surfaces mated together. FIG. 6F is a left perspective view of the five-chamber coin container without a lip extension assembly with five coin stacks, and two rubber bands securing the two five-chamber coin container halves without lips. Each rubber band can be placed along the narrow portion of the five-chamber coin container without a lip extension assembly 162 as illustrated, along the spine recess area of each respective halve. The multi-chamber coin container of the present embodiment may offer the further benefit of improved durability as exclusion of the lip recess eliminates an area with decreased container wall thickness and thereby may improve container durability.

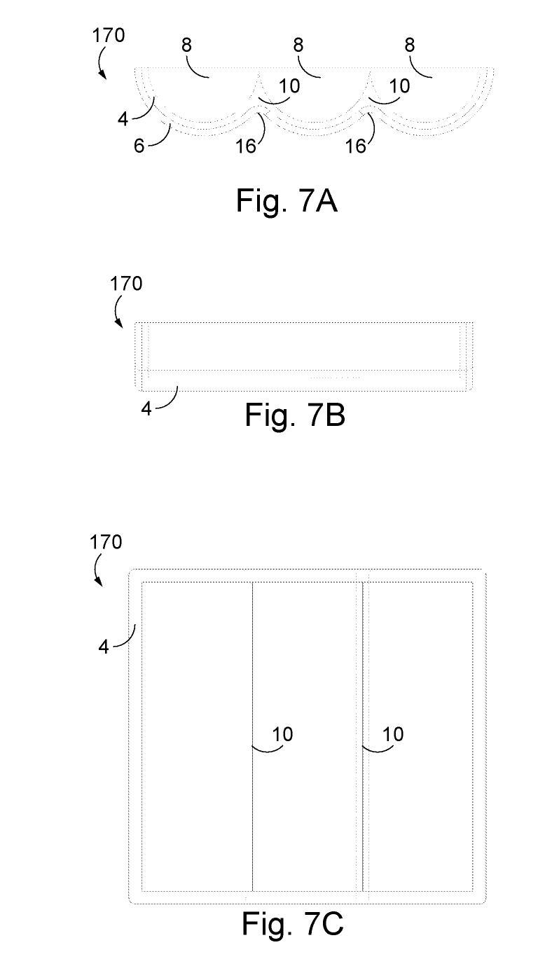

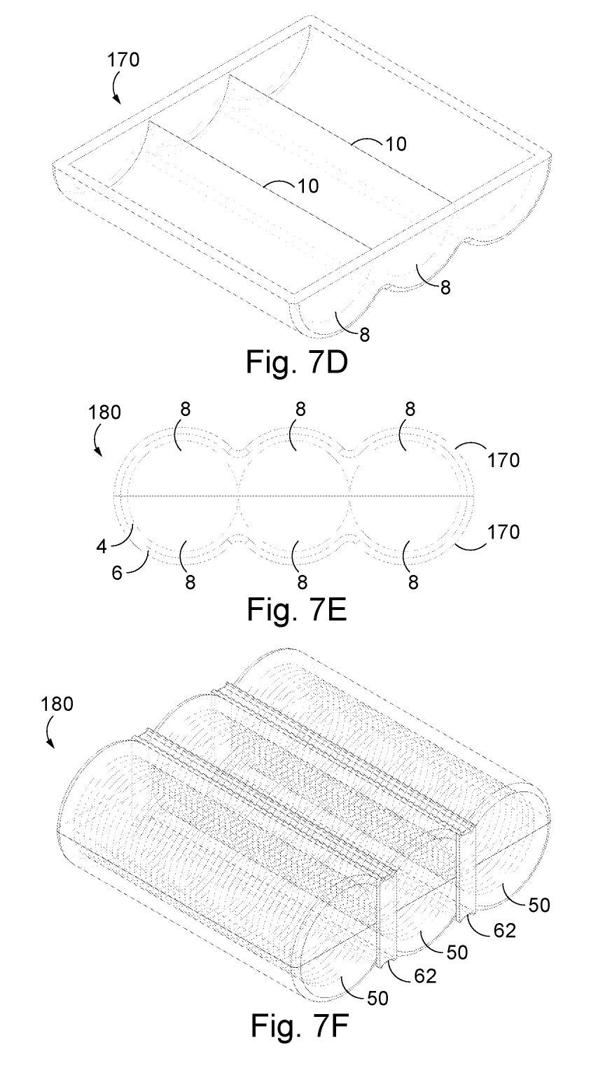

FIGS. 7A, 7B and 7C are front, left and top views, respectively, of a three-chamber coin container halve with a tall spine 170, used in duplicate, in accordance with one exemplary embodiment of the multi-chamber coin container of the present invention. The three-chamber coin container halve with a tall spine, material and steps for manufacture are the same as that illustrated and described in FIGS. 6A to 6F with a few differences, which are described below. The three-chamber coin container halve with a tall spine also includes container wall 4 and filleted edge 6. Three of coin chamber 8 are included for accommodation of three stacks of coin currency and two of spine 10 are located between individual coin chambers. The spine is extended vertically towards the top surface of the three-chamber coin container halve. This extended spine provides the advantage of further securing coins while in use. With the tall spines, the three-chamber coin container with a tall spine, when used in duplicate form as a container assembly, can help keep coins from moving between chambers if the coin container is only partially full. Thus, the tall spine helps to retain coins in the chambers in which they have been placed by the user while in use as a coin container assembly, with the respective halves used in duplicate. Also, neither a lip extension nor lip recess are included in this embodiment so similar advantages may be afforded in durability by omitting the lip recess. Along the undersurface of the three-chamber coin container halve with a tall spine 170 are two of spine recess 16 allowing for ease of stacking with a space-saving fit, when fully assembled as two halves, and then stacked vertically. FIG. 7D is a left perspective view further illustrating the location of each coin chamber 8. FIG. 7E is a front view of a three-chamber coin container with a tall spine assembly 180 comprised of two three-chamber coin container halves with tall spines 170 illustrating the fit achieved once assembled with two halves in an opposing orientation with their top surfaces mated together. FIG. 7F is a left perspective view of the three-chamber coin container with a tall spine assembly with five coin stacks, and two rubber bands securing the three-chamber coin container halves with tall spines. Each rubber band can be placed along the narrow portion of the three-chamber coin container with a tall spine assembly 180 as illustrated, along the spine recess area of each respective halve. The multi-chamber coin container of the present embodiment may offer the further benefit of improved retention of coins within the coin chamber in which they have been placed by the user, when the coin container assembly is used in a partially-filled scenario, without all coin chambers completely filled with coins.

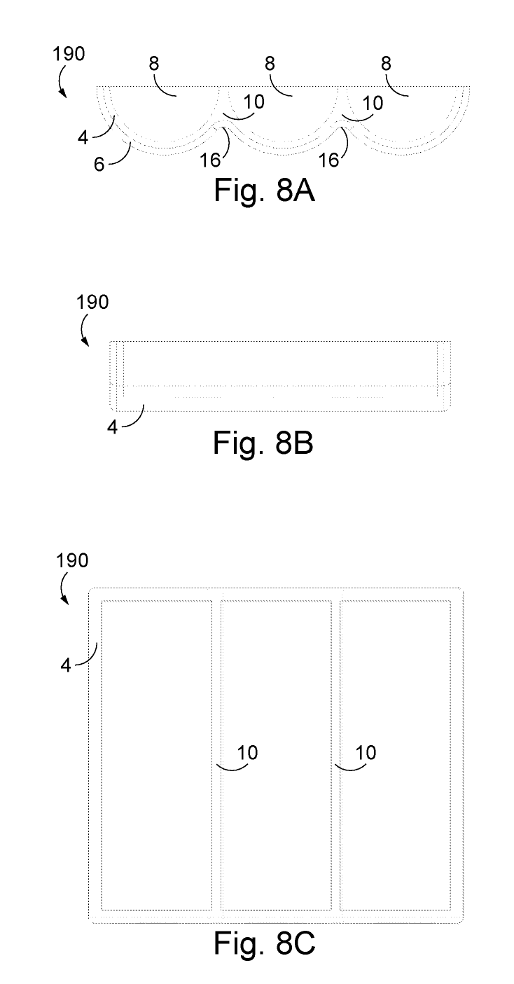

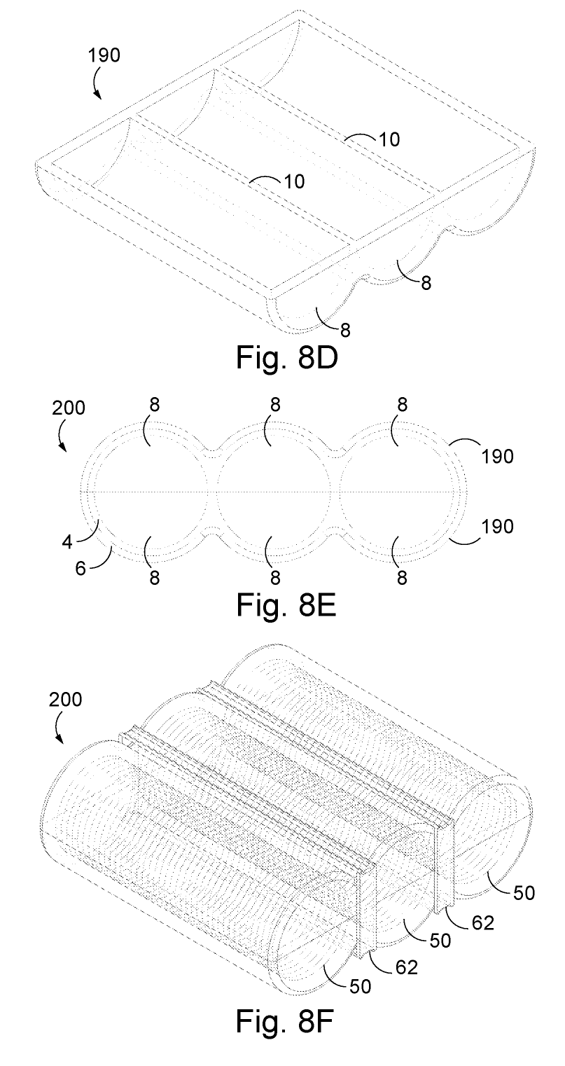

FIGS. 8A, 8B and 8C are front, left and top views, respectively, of a three-chamber coin container halve with a full spine 190, used in duplicate, in accordance with one exemplary embodiment of the multi-chamber coin container of the present invention. The three-chamber coin container halve with a full spine, material and steps for manufacture are the same as that illustrated and described in FIGS. 7A to 7F with a few differences, which are described below. three-chamber coin container halve with a full spine also includes container wall 4 and filleted edge 6. Also included are three of coin chamber 8 for accommodation of three stacks of coin currency and two of spine 10 are located between individual coin chambers. The spine is fully extended vertically towards the top surface of the three-chamber coin container halve. This extended spine provides the advantage of further securing coins while in use. This embodiment includes full spines which reach the level of the top surface of container wall 4. When the three-chamber coin container with a full spine, is used in duplicate to form as a container assembly it may further help retain coins within coin chambers, when only partially filled. Thereby, the full spine may help retain coins within the chamber in which they have been placed by the user with a decreased likelihood of shifting between chambers while in use as a coin container assembly, with the respective halves used in duplicate. Additionally, neither a lip extension nor lip recess are included in this embodiment so similar advantages may be afforded in durability by omitting the lip recess. Along the undersurface of the three-chamber coin container halve with a full spine 190 are two of spine recess 16 allowing for ease of stacking with a space-saving fit, when fully assembled as two halves, and then stacked vertically. FIG. 8D is a left perspective view further illustrating the location of each coin chamber 8. FIG. 8E is a front view of a three-chamber coin container with a full spine assembly 200 comprised of two three-chamber coin container halve with full spines 190 illustrating the fit achieved once assembled with two halves in an opposing orientation with their top surfaces mated together. FIG. 8F is a left perspective view of the three-chamber coin container with a full spine assembly 200 with five coin stacks, and two rubber bands securing the three-chamber coin container halves with full spines. Each rubber band can be placed along the narrow portion of the three-chamber coin container with a full spine assembly 200 as illustrated, along the spine recess area of each respective halve. The multi-chamber coin container of the present embodiment may offer the benefit of further allowing for improved retention of coins within the coin chamber in which they have been placed by the user, when the coin container assembly is used in a partially-filled scenario, without all chambers filled with coin stacks. The inclusion of the full spine further seals individual each chamber and thus may offer improved resistance to coin movement between chambers.

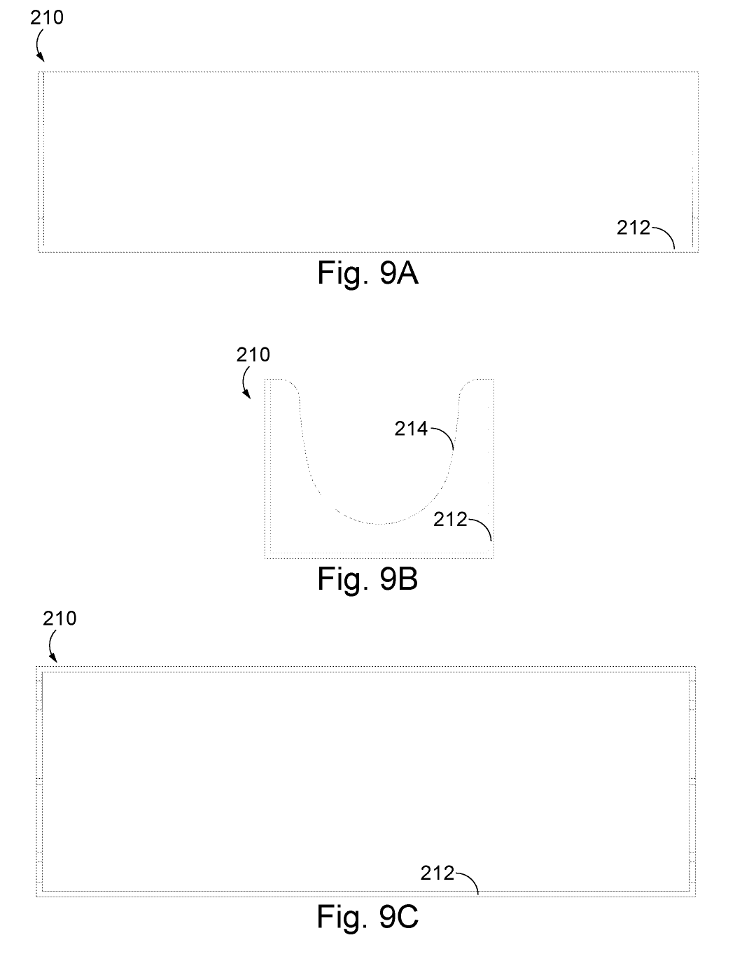

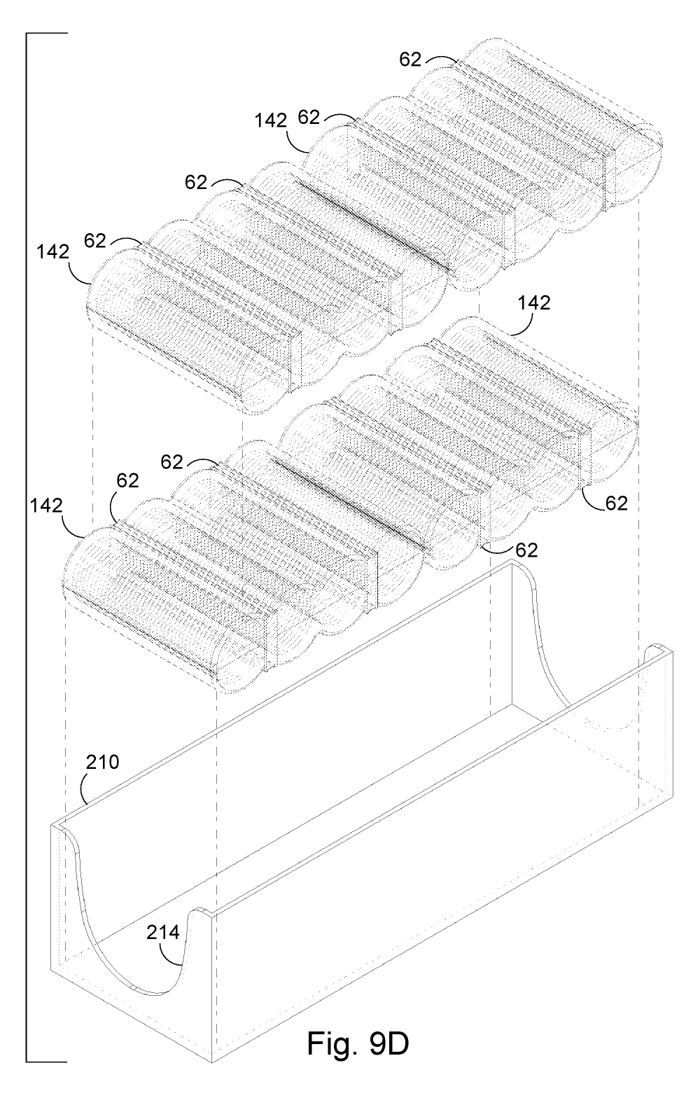

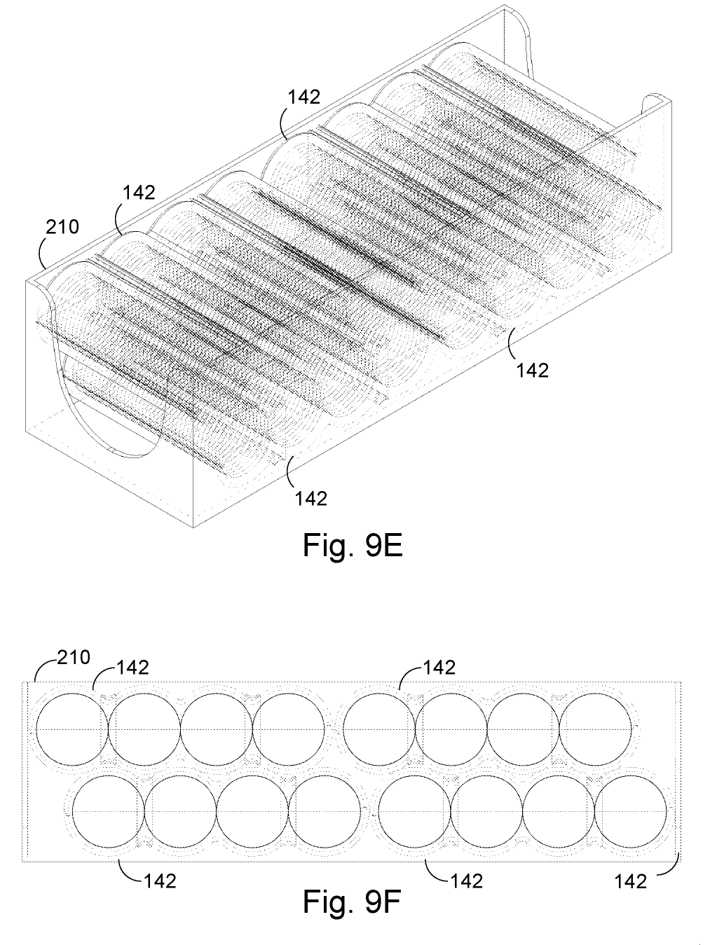

FIGS. 9A, 9B and 9C are front, left, and top views respectively, of a coin tray 210, used for storage and transportation of multi-chamber coin containers in accordance with one exemplary embodiment of the multi-chamber coin container of the present invention. The coin tray is comprised of coin tray wall 212 and includes two of coin tray window 214. Inclusion of the two coin tray windows allows for further visual inspection of multi-chamber coin containers when stored within the coin tray. FIG. 9D is an exploded left perspective view of four of four-chamber coin containers with central lip extension assembly 142, each including four coin stacks and secured with two of rubber band 62, into one coin tray 210. The four-chamber coin containers with central lip extension assembly allow for ease of vertical stacking as described above. FIGS. 9E and 9F are left perspective and front views, respectively, further illustrating four of four-chamber coin container with central lip extension assembly, each including four coin stacks and secured with two rubber bands each, into one coin tray. The two coin tray windows allow for visualization of the multi-chamber coin containers stored within the coin tray.

The coin tray may be produced for multi-chamber coin containers of varying sizes. This is achieved by changing the width, height and depth dimensions of the coin tray walls to accommodate larger or smaller multi-chamber coin containers. For example, if the coin needs to store multi-chamber coin container of a wider width dimension, such as a 5-chamber coin container, the overall width dimension of the container may be increased. It may also be made wider to store additional multi-chamber coin containers. The converse is also true whereby the coin tray overall width may be decreased to accommodate a smaller multi-chamber coin container or smaller number of coin containers. The depth and height dimensions may also be modified in order to accommodate multi-chamber coin containers for alternate currency with different coin dimensions.

The coin tray of this embodiment may be manufactured using a metal such as aluminum or another suitable metal or metal alloy or carbon fiber. Additionally, a polymer such as polycarbonate material may be used. Additionally, it may be manufactured using an alternate polymer including polyethylene, polypropylene, polyvinyl chloride. Alternate materials can also be used to manufacture the coin tray including silicone, metal including aluminum, or a metal alloy including steel or other suitable material. If the coin tray is produced with polycarbonate it may be manufactured through injection molding or other molding technique or thermoformed as known in the art and further contoured as desired. If polycarbonate is used in the manufacture, it may also be transparent polycarbonate as known in the art. If metal is used in the manufacture, it can be formed as cast, forged, and further machined or alternate process as known in the art. The surface can be further polished, painted, stained or anodized if aluminum is utilized, as known in the art.

The multi-chamber coin container of the present invention provides for storage and transport of coin-based currency, simplicity of use for coin storage, ease of assembly and disassembly, ease of visual inspection, and is reusable. It can be used by an individual for storage and transport of coin-based currency. The multi-chamber coin container allows for ease of coin collection, using the container, as the length of each chamber corresponds to a set number of coins. Therefore, coin counting is unnecessary as the multi-chamber coin container is successively filled with coins of a coin denomination by the user until each chamber is filled. This saves time for the user as compared to counting individual coins and assembly of coin stacks into paper-based coin rolls, commonly used for banking deposits. This ease of use simplifies the deposit process for coins, as coins do not need to be counted for deposits saving time for the banking customer. The multi-chamber coin container may then be transported by the user to the banking institution which may have an arrangement in place allowing for acceptance of deposits with the multi-chamber coin container.

While the above description contains much specificity, this should not be construed as limitations on the scope, but rather an exemplification of one or more exemplary embodiments as detailed. Multiple additional configurations are possible of the multi-chamber coin container and coin tray. Inclusion of a different number of coin chambers in the described multi-chamber coin container embodiments is possible with, but not limited to ten or more coin chambers. The width, depth and height of the multi-chamber coin container halves may be enlarged or reduced depending on the coin dimensions for which they are intended. The coin tray may also be enlarged to accept more multi-chamber coin containers or multi-chamber coin containers of a larger or smaller size. The coin tray may also have reduced or increased number of coin tray windows. Coin tray windows may also be added along the front and back of the coin tray. Any of the illustrated multi-chamber coin containers may have an alternate lip extension or lip recess or omission of the lip extension and/or lip recess or alternate combination. For example, the two-chamber coin container may have a central lip extension and central lip recess, or the lip extension and lip recess may both be omitted. Any of the illustrated multi-chamber coin container may have an alternate spine as well including the tall spine or full spine or a spine of a reduced height. The multi-chamber coin container can also be manufactured with a single coin chamber, effectively making it a single-chamber coin container, but the multi-chamber design is preferred as it allows for bulk coin storage.

It will be appreciated that although the present disclosure has been described with reference to particular materials, manufacturing methods and joining methods, other suitable materials such as, for example, alternate plastics, other manufacturing methods such as, for example, injection molding, laser cutting or alternate machining methods, and other joining methods such as, for example, friction fitting may be used. Moreover, while example implementations have been described with specific features/arrangements of features, the features described in any of the implementations may be used in any combination (e.g., number of chambers and various options for spine configurations, lip extensions, lip recesses, and the omission thereof, etc.).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A multi-chamber coin container, comprising:
two symmetrical coin container halves configured for containing a plurality of stacks of coins or stacks of coin-shaped objects for bulk storage, when the coin container halves are assembled in an opposing orientation with their top surfaces mated together.

2. The multi-chamber coin container according to claim 1 further comprising container halves including at least one outer lip extension.

3. The multi-chamber coin container according to claim 1 further comprising container halves including at least one outer lip recess.

4. The multi-chamber coin container according to claim 1 further comprising container halves including at least one spine.

5. The multi-chamber coin container according to claim 1 further comprising container halves including at least one spine recess.

6. The multi-chamber coin container according to claim 1 further comprising container halves including at least one central lip extension.

7. The multi-chamber coin container according to claim 1 further comprising container halves including at least one central lip recess.
